(19) United States
(12) Patent Application Publication
(10) Pub. No.: US 2020/0393776 A1
(43) Pub. Date: Dec. 17, 2020

(54) ELECTROSTATIC OVERCOAT COMPOSITION

(71) Applicant: Hewlett-Packard Development Company, L.P., Spring, TX (US)

(72) Inventors: Inna Tzomik, Nes Ziona (IL); Faina Kogan, Nes Ziona (IL); Katty Noorany, Nes Ziona (IL)

(21) Appl. No.: 16/772,583

(22) PCT Filed: Jan. 19, 2018
(86) PCT No.: PCT/US2018/014438

§ 371 Date: Jun. 12, 2020

(51) Int. Cl. G03G 9/135; C09D 11/033; C09D 11/12; C09D 11/107; G03G 9/125; G03G 9/13; G03G 9/12

(52) U.S. Cl. CPC G03G 9/1355; C09D 11/033; C09D 11/12; G03G 9/122; G03G 9/125; G03G 9/131; C09D 11/107

(57) ABSTRACT

Described herein is a printed product and a process for preparing a printed product. The process may comprise providing a printed substrate comprising an electrostatic ink layer on a surface of a substrate, the electrostatic ink layer comprising a first thermoplastic resin and a pigment; and electrostatically printing an electrostatic overcoat composition onto the printed substrate, the electrostatic overcoat composition comprising a second thermoplastic resin and a wax. Also described herein is an electrostatic overcoat composition, as well as an ink set comprising an electrostatic ink composition and an electrostatic overcoat composition.

### BACKGROUND

In liquid electrostatic printing, a photoconductive surface is selectively charged with a latent electrostatic image having image and background areas with different potential. A liquid electrostatic ink composition, containing charged toner particles in a carrier liquid, is brought into contact with the selectively charged photoconductive surface, the charged toner particles adhering only to the image areas of the latent image and leaving the background areas clean of toner particles. The image is then transferred to a substrate via an intermediate transfer member, which is often referred to as a blanket.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a paper substrate or plastic film. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/μm, or more, in some examples, 600-900V/μm, or more.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

As used herein, “lamination bond strength” refers to the force (per length) required to delaminate/remove a tape adhered to a printed product, and is expressed in units of Newton/inch, or N/in. The lamination bond strength can be measured according to standard techniques, in particular ASTM F0904-98R08. Unless otherwise stated, the lamination bond strength described herein refers to the strength required to delaminate/remove a tape (e.g., an adhesive tape such as Scotch tape 810 available from 3M) from the printed product at the interface between the electrostatic overcoat composition and the tape.

Unless otherwise stated, any feature described herein can be combined with any aspect or any other feature described herein.

In an aspect, there is provided a process for preparing a printed product. The process for preparing a printed product may comprise:
providing a printed substrate comprising an electrostatic ink layer on a surface of a substrate, the electrostatic ink layer comprising a first thermoplastic resin and a pigment; and
electrostatically printing an electrostatic overcoat composition onto the printed substrate, the electrostatic overcoat composition comprising a second thermoplastic resin and a wax.

In another aspect, there is provided a printed product. The printed product may comprise:
a substrate;
an electrostatic ink layer disposed on the substrate, wherein the electrostatic ink layer comprises a first thermoplastic resin and a pigment; and
an overcoat layer disposed on the electrostatic ink layer, the overcoat layer comprising an electrostatic overcoat composition comprising a second thermoplastic resin and a wax.

In a further aspect, there is provided an ink set. The ink set may comprise:
an electrostatic ink composition comprising a first thermoplastic resin and a pigment; and
an electrostatic overcoat composition comprising a second thermoplastic resin and a wax, wherein the wax constitutes at least 5 wt. % of the solids of the electrostatic overcoat composition.

In another aspect, there is provided an electrostatic overcoat composition. The electrostatic overcoat composition may comprise:
a thermoplastic resin; and
a wax;
   wherein the wax is selected from fatty acid esters and fatty acid amides; and
   wherein the wax constitutes at least 5 wt. % of the solids of the electrostatic overcoat composition.

Once a printed product has been printed, a variety of post printing (finishing) processes may be performed that can damage the liquid electrostatic ink layer. Moreover, sticky notes and other adhesive products are frequently adhered to printed products and then removed. However, removal of sticky notes and other adhered products from printed products produced in liquid electrostatic printing processes frequently results in removal of the printed ink layer.

The present inventors have found that examples of the processes and products as described herein avoid or at least mitigate at least one of the difficulties described above. They have found that examples of the process and products enable the use of the same machine to apply the electrostatic overcoat composition as is used to electrostatically print the electrostatic ink layer. Moreover, the use of an electrostatic overcoat composition of the presently described type increases the hydrophobicity of the printed product whilst also reducing the adhesion of sticky notes and other adhesive products to the printed product.

Printed Product

In some examples, a printed product is provided. The printed product may be produced by any of the methods or processes described herein. Each component of the printed product will be discussed in the sections which follow.

In some examples, the printed product may comprise a substrate; an electrostatic ink layer disposed on the substrate; and an overcoat layer disposed on the electrostatic ink layer. In some examples, the electrostatic ink layer may comprise a first thermoplastic resin and a pigment. In some examples, the overcoat layer may comprise an electrostatic overcoat composition comprising a second thermoplastic resin and a wax.

In some examples, the printed product may comprise a substrate; an electrostatic ink layer disposed on the substrate, wherein the electrostatic ink layer comprises a first thermoplastic resin and a pigment; and an overcoat layer disposed on the electrostatic ink layer, the overcoat layer comprising an electrostatic overcoat composition comprising a second thermoplastic resin and a wax.

In some examples, the printed product may comprise a printed substrate and an overcoat layer disposed on the electrostatic ink layer of the printed substrate.

Printed Substrate

In some examples, the printed substrate comprises an electrostatic ink layer on a surface of a substrate. In some examples, the electrostatic ink layer comprises a first thermoplastic resin and a pigment. In some examples, the printed substrate comprises an electrostatic ink layer on a surface of a substrate, the electrostatic ink layer comprising a first thermoplastic resin and a pigment.

In some examples, the printed substrate may comprise a primer layer disposed between the electrostatic ink layer and the surface of the substrate.

Substrate

In some examples, the substrate may be any suitable substrate capable of having an image printed thereon. In some examples, the substrate may be any substrate suitable for use in a printed product. In some examples, the substrate may be any substrate suitable for use in an electrostatic printer. In some examples, the substrate may be any substrate suitable for use in a liquid electrostatic printer.

In some examples, the substrate may include a material selected from an organic or inorganic material. The substrate may include a natural polymeric material, for example, cellulose. The substrate may include a synthetic polymeric material, for example, a polymer formed from alkylene monomers, including, for example, polyethylene and polypropylene, and co-polymers, such as styrene-polybutadiene. In some examples, the polypropylene may be biaxially oriented polypropylene.

In some examples, the substrate may be a paper substrate. In some examples, the paper substrate may be an uncoated paper substrate. In some examples, the paper substrate may be a coated paper substrate.

In some examples, the substrate may be or comprise a cellulosic substrate, such as a cellulosic paper. In some examples, the cellulosic substrate may be or comprise an uncoated cellulosic substrate, that is, absent of a coating of a polymer material. In some examples the cellulosic substrate may be a coated cellulosic substrate. In some examples, the cellulosic substrate, which may be a cellulosic paper, is coated with a polymeric material, for example, a polymer formed from styrene-butadiene resin. In some examples, the cellulosic paper has an inorganic material bound to its surface (before an electrostatic ink layer or, if present, a primer layer is applied) with a polymeric material, wherein the inorganic material may be selected from, for example, kaolinite or calcium carbonate.

In some examples, the substrate is a cellulosic substrate such as paper. The cellulosic substrate is, in some examples, a coated cellulosic substrate. In some examples, the substrate is a transparent substrate, for example, the substrate may be formed from a transparent material such as a transparent polymeric material, for example, a polymer formed from alkylene monomers, including, for example, polyethylene and polypropylene, and co-polymers such as styrene-polybutadiene.

In some examples, the substrate may be cardboard.

In some examples, the substrate may comprise a polymeric material. In some examples, the polymeric material may comprise a transparent polymeric material. In some examples, the substrate comprises a film, for example, a thin film, of a polymeric material. In some examples, the polymeric material may comprise a polymer formed from alkylene monomers, including, for example, polyethylene and polypropylene, and co-polymers such as styrene-polybutadiene. In some examples, the polymeric material may comprise polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA) or polyethylene terephthalate (PET).

In some examples, the substrate may be or comprise a metal, which may be in sheet form. In some examples, the substrate may comprise a metallic foil or a metallized substrate. In some examples, the substrate may comprise a metallized paper (i.e. paper having a metal layer thereon) or a metallized plastic film (i.e. plastic film having a metal layer thereon). In some examples, the metal may be selected from or made from, for example, aluminium (Al), silver (Ag), tin (Sn), copper (Cu), or mixtures thereof. In some examples, the substrate may comprise an aluminium foil.

In some examples, the substrate may be 600 μm or less in thickness, for example, 250 μm or less in thickness, for example, 200 μm or less in thickness, for example, 150 μm or less in thickness, for example, 100 μm or less in thickness, for example, 90 μm or less in thickness, for example, 80 μm or less in thickness, 70 μm or less in thickness, 60 μm or less in thickness, 50 μm or less in thickness, 40 μm or less in thickness, 30 μm or less in thickness, 20 μm or less in thickness, 15 μm or less in thickness, 12 μm or less in thickness, 10 μm or less in thickness. In some examples, the substrate may be 10 μm or more in thickness, for example, 12 μm or more in thickness, 15 μm or more in thickness, 20 μm or more in thickness, 30 μm or more in thickness, 40 μm or more in thickness, 50 μm or more in thickness, 60 μm or more in thickness, 70 μm or more in thickness, 80 μm or more in thickness, 90 μm or more in thickness, 100 μm or more in thickness. In some examples, the substrate may be 10 μm to 100 μm in thickness, for example, 12 μm to 90 μm in thickness, 15 μm to 80 μm in thickness, 20 μm to 70 μm in thickness, 30 μm to 60 μm in thickness, 40 μm to 50 μm in thickness.

In some examples, the substrate may be selected from paper, card or cardboard and have a weight measured according to ISO 536 of 100 g/m² or more, in some examples, 110 g/m² or more, in some examples, 115 g/m² or more, in some examples, 120 g/m² or more, in some examples, 130 g/m² or more, in some examples, 140 g/m² or more, in some examples, 150 g/m² or more, in some examples, 160 g/m² or more, in some examples, 170 g/m² or more, in some examples, 180 g/m² or more, in some examples, 190 g/m² or more, in some examples, 200 g/m² or more, in some examples, 250 g/m² or more, in some examples, 300 g/m² or more, in some examples, 350 g/m² or more, in some examples, 400 g/m² or more, in some examples, 450 g/m² or more, in some examples, 500 g/m² or more, in some examples, 550 g/m² or more, in some examples, 600 g/m² or more, in some examples, 700 g/m² or more, in some examples, 1000 g/m² or more. In some examples, the substrate may be selected from paper, card or cardboard and have a weight measured according to ISO 536 of 1000 g/m² or less, in some examples, 700 g/m² or less, in some examples, 600 g/m² or less, in some examples, 550 g/m² or less, in some examples, 500 g/m² or less, in some examples, 450 g/m² or less, in some examples, 400 g/m² or less, in some examples, 350 g/m² or less, in some examples, 300 g/m² or less, in some examples, 250 g/m² or less, in some examples, 200 g/m² or less, in some examples, 190 g/m² or less, in some examples, 180 g/m² or less, in some examples, 170 g/m² or less, in some examples, 160 g/m² or less, in some examples, 150 g/m² or less, in some examples, 140 g/m² or less, in some examples, 130 g/m² or less, in some examples, 120 g/m² or less, in some examples, 115 g/m² or less, in some examples, 110 g/m² or less, in some examples, 100 g/m² or less. In some examples, the substrate may be selected from paper, card or cardboard and have a weight measured according to ISO 536 of 100 g/m² to 1000 g/m², in some examples, 110 g/m² to 700 g/m², in some examples, 115 g/m² to 600 g/m², in some examples, 120 g/m² to 550 g/m², in some examples, 130 g/m² to 500 g/m², in some examples, 140 g/m² to 450 g/m², in some examples, 150 g/m² to 400 g/m², in some examples, 160 g/m² to 350 g/m², in some examples, 170 g/m² to 300 g/m², in some examples, 180 g/m² to 200 g/m², in some examples, 190 g/m² to 200 g/m².

Electrostatic Ink Layer

The electrostatic ink layer may comprise a first thermoplastic resin and a pigment. In some examples, the electrostatic ink layer may be on a surface of a substrate. In some examples, the electrostatic ink layer may have been or may be applied to the surface of a substrate by printing an electrostatic ink composition on a surface of a substrate. In some examples, the electrostatic ink layer may have been or may be applied to the surface of a substrate by electrostatically printing an electrostatic ink composition on a surface of a substrate. In some examples, the electrostatic ink layer may have been or may be applied to the surface of a substrate by liquid electrostatically printing a liquid electrostatic ink composition on a surface of a substrate.

In some examples, the electrostatic ink layer may be derived from an electrostatic ink composition that has been electrostatically printed on a surface of the substrate. In some examples, the liquid electrostatic ink layer may be derived from a liquid electrostatic ink composition that has been liquid electrostatically printed on a surface of the substrate.

Electrostatic Ink Composition

In some examples, the electrostatic ink layer may comprise an electrostatic ink composition. The electrostatic ink composition, which may be or have been printed onto a surface of the substrate, may comprise a first thermoplastic resin and a pigment.

The electrostatic ink composition, which may be or have been printed onto a surface of the substrate, for example, a surface of the substrate on which a primer is disposed, may comprise a first thermoplastic resin and a pigment.

In some examples, the electrostatic ink composition may be a dry electrostatic ink composition, also known as a toner. In some examples, the electrostatic ink composition may be a liquid electrostatic ink composition.

Liquid electrophotographic printing, or electrostatic printing, is one method by which images or information (i.e., an electrostatic ink layer) can be printed onto a surface of a substrate, such as paper or plastic. The printing processes generally involve creating an image on a photoconductive surface, applying an ink having charged particles to the photoconductive surface, such that they selectively bind to the image, and then transferring the charged particles in the form of the image to a surface of a substrate.

The electrostatic ink composition (which, once printed, forms the electrostatic ink layer) printed on the surface of a substrate described herein may be a liquid electrophotographic printing composition (also referred to herein as an LEP composition or a liquid electrostatic ink composition) printed on the surface of a substrate using a liquid electrophotographic printing process, for example, an LEP printing process. In some examples, the electrostatic ink composition may comprise a first thermoplastic resin and a pigment. An LEP composition may comprise a first thermoplastic resin, a pigment and a carrier fluid or liquid. The LEP composition may further comprise an additive such as a charge director, charge adjuvant, surfactant, viscosity modifier, emulsifier and the like or a combination thereof. In some examples, the LEP composition may not contain any pigment, or may comprise substantially zero pigment and thus be a pigment-free composition, useful in providing a particular transparent gloss or sheen to a printed substrate.

In some examples, after printing, an LEP ink composition, which may be printed on the surface of a substrate (forming an electrostatic ink layer), may comprise a reduced amount of carrier liquid compared with the LEP printing composition before printing. In some examples, after printing, an electrostatic ink composition, which may be printed on a surface of the substrate, may be substantially free from carrier liquid. Substantially free from carrier liquid may indicate that the ink printed on a surface of the substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, an electrostatic ink composition that may be printed on a surface of the substrate is free from carrier liquid.

Each of these components of an electrostatic ink composition, which may be the electrostatic ink layer printed on a surface of the substrate, will be described separately in the sub-sections which follow.

Pigment

An electrostatic ink composition may comprise a pigment. The pigment can be any colorant compatible with the liquid carrier and useful for electrophotographic printing. For example, the pigment may be present as pigment particles, or may comprise a resin (in addition to the polymers described herein) and a pigment. In some examples, the pigment is selected from a cyan pigment, a magenta pigment, a yellow pigment, a white pigment and a black pigment. In some examples, the pigment is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. Where the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment.

In some examples, the pigment particles may have a median particle size or d₅₀ of less than 20 μm, for example, less than 15 μm, for example, less than 10 μm, for example, less than 5 μm, for example, less than 4 μm, for example, less than 3 μm, for example, less than 2 μm, for example, less than 1 μm, for example, less than 0.9 μm, for example, less than 0.8 μm, for example, less than 0.7 μm, for example, less than 0.6 μm, for example, less than 0.5 μm. Unless otherwise stated, the particle size of the pigment particle and the resin coated pigment particle is determined by using laser diffraction on a Malvern Mastersizer 2000 according to the standard procedure as described in the operating manual.

The pigment particle may be present in an electrostatic ink composition in an amount of from 10 wt. % to 80 wt. % of the total amount of resin and pigment, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. % of the total amount of resin and pigment. In some examples, the pigment particle may be present in an electrostatic ink composition in an amount of at least 50 wt. % of the total amount of resin and pigment, for example, at least 55 wt. % of the total amount of resin and pigment.

First Thermoplastic Resin

In some examples, the electrostatic ink composition comprises a polymer resin, also referred to herein as the first thermoplastic resin to distinguish it from the thermoplastic resin of the overcoat.

In some examples, the electrostatic ink composition comprises a polymer resin comprising a polymer having acidic side groups. In some examples, an electrostatic ink composition comprises a polymer resin comprising a copolymer of an alkylene monomer and a monomer selected from acrylic acid and methacrylic acid.

In some examples, the first thermoplastic resin comprises or consists of a polymer having acidic side groups. In some examples, the first thermoplastic resin comprises a copolymer of an alkylene monomer and a monomer selected from acrylic acid and methacrylic acid. In some examples, the first thermoplastic resin comprises a copolymer of an alkylene monomer selected from ethylene and propylene and a monomer selected from acrylic acid and methacrylic acid.

The polymer resin or first thermoplastic resin may be referred to as a thermoplastic polymer. In some examples, the polymer resin may comprise ethylene or propylene acrylic acid co-polymers; ethylene or propylene methacrylic acid co-polymers; ethylene vinyl acetate co-polymers; co-polymers of ethylene or propylene (e.g. 80 wt. % to 99.9 wt. %), and alkyl (e.g. C1 to C5) ester of methacrylic or acrylic acid (e.g. 0.1 wt. % to 20 wt. %); co-polymers of ethylene (e.g. 80 wt. % to 99.9 wt. %), acrylic or methacrylic acid (e.g. 0.1 wt. % to 20.0 wt. %) and alkyl (e.g. C1 to C5) ester of methacrylic or acrylic acid (e.g. 0.1 wt. % to 20 wt. %); co-polymers of ethylene or propylene (e.g. 70 wt. % to 99.9 wt. %) and maleic anhydride (e.g. 0.1 wt. % to 30 wt. %); polyethylene; polystyrene; isotactic polypropylene (crystalline); co-polymers of ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers or combinations thereof.

The polymer resin may comprise a polymer having acidic side groups. Examples of the polymer having acidic side groups will now be described. The polymer having acidic side groups may have an acidity of 50 mg KOH/g or more, in some examples, an acidity of 60 mg KOH/g or more, in some examples, an acidity of 70 mg KOH/g or more, in some examples, an acidity of 80 mg KOH/g or more, in some examples, an acidity of 90 mg KOH/g or more, in some examples, an acidity of 100 mg KOH/g or more, in some examples, an acidity of 105 mg KOH/g or more, in some examples, 110 mg KOH/g or more, in some examples, 115 mg KOH/g or more. The polymer having acidic side groups may have an acidity of 200 mg KOH/g or less, in some examples, 190 mg or less, in some examples, 180 mg or less, in some examples, 130 mg KOH/g or less, in some examples, 120 mg KOH/g or less. Acidity of a polymer, as measured in mg KOH/g can be measured using standard procedures, for example, using the procedure described in ASTM D1386.

The polymer resin may comprise a polymer having acidic side groups, that has a melt flow rate of less than about 70 g/10 minutes, in some examples, about 60 g/10 minutes or less, in some examples, about 50 g/10 minutes or less, in some examples, about 40 g/10 minutes or less, in some examples, 30 g/10 minutes or less, in some examples, 20 g/10 minutes or less, in some examples, 10 g/10 minutes or less. In some examples, all polymers having acidic side groups and/or ester groups in the particles each individually have a melt flow rate of less than 90 g/10 minutes, 80 g/10 minutes or less, in some examples, 70 g/10 minutes or less, in some examples, 60 g/10 minutes or less.

The polymer having acidic side groups can have a melt flow rate of about 10 g/10 minutes to about 120 g/10 minutes, in some examples, about 10 g/10 minutes to about 70 g/10 minutes, in some examples, about 10 g/10 minutes to 40 g/10 minutes, in some examples, 20 g/10 minutes to 30 g/10 minutes. The polymer having acidic side groups can have a melt flow rate of, in some examples, about 50 g/10 minutes to about 120 g/10 minutes, in some examples, 60 g/10 minutes to about 100 g/10 minutes. The melt flow rate can be measured using standard procedures, for example, as described in ASTM D1238.

The acidic side groups may be in free acid form or may be in the form of an anion and associated with a counterion, generally metal counterions, for example, a metal selected from the alkali metals, such as lithium, sodium and potassium, alkali earth metals, such as magnesium or calcium, and transition metals, such as zinc. The polymer having acidic side groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitutes from 5 wt. % to about 25 wt. % of the co-polymer, in some examples, from 10 wt. % to about 20 wt. % of the co-polymer.

The polymer resin may comprise two different polymers having acidic side groups. The two polymers having acidic side groups may have different acidities, which may fall within the ranges mentioned above. The polymer resin may comprise a first polymer having acidic side groups that has an acidity of from 10 mg KOH/g to 110 mg KOH/g, in some examples, 20 mg KOH/g to 110 mg KOH/g, in some examples, 30 mg KOH/g to 110 mg KOH/g, in some examples, 50 mg KOH/g to 110 mg KOH/g, and a second polymer having acidic side groups that has an acidity of 110 mg KOH/g to 130 mg KOH/g.

The polymer resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples, 20 mg KOH/g to 110 mg KOH/g, in some examples, 30 mg KOH/g to 110 mg KOH/g, in some examples, 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples, about 4:1.

The polymer resin may comprise a polymer having a melt viscosity of 15000 poise or less, in some examples, a melt viscosity of 10000 poise or less, in some examples, 1000 poise or less, in some examples, 100 poise or less, in some examples, 50 poise or less, in some examples, 10 poise or less; said polymer may be a polymer having acidic side groups as described herein. The polymer resin may comprise a first polymer having a melt viscosity of 15000 poise or more, in some examples, 20000 poise or more, in some examples, 50000 poise or more, in some examples, 70000 poise or more; and in some examples, the polymer resin may comprise a second polymer having a melt viscosity less than the first polymer, in some examples, a melt viscosity of 15000 poise or less, in some examples, a melt viscosity of 10000 poise or less, in some examples, 1000 poise or less, in some examples, 100 poise or less, in some examples, 50 poise or less, in some examples, 10 poise or less. The polymer resin may comprise a first polymer having a melt viscosity of more than 60000 poise, in some examples, from 60000 poise to 100000 poise, in some examples, from 65000 poise to 85000 poise; a second polymer having a melt viscosity of from 15000 poise to 40000 poise, in some examples, 20000 poise to 30000 poise, and a third polymer having a melt viscosity of 15000 poise or less, in some examples, a melt viscosity of 10000 poise or less, in some examples, 1000 poise or less, in some examples, 100 poise or less, in some examples, 50 poise or less, in some examples, 10 poise or less; an example of the first polymer is Nucrel 960 (from DuPont), and example of the second polymer is Nucrel 699 (from DuPont), and an example of the third polymer is AC-5120 or AC-5180 (from Honeywell). The polymer resin may comprise a first polymer having a melt viscosity of from 15000 poise to 40000 poise, in some examples, 20000 poise to 30000 poise, and a second polymer having a melt viscosity of 15000 poise or less, in some examples, a melt viscosity of 10000 poise or less, in some examples, 1000 poise or less, in some examples, 100 poise or less, in some examples, 50 poise or less, in some examples, 10 poise or less; an example of the first polymer is Nucrel 699 (from DuPont), and an example of the second polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the polymer resin comprises a single type of polymer, the polymer (excluding any other components of the electrophotographic ink composition) may have a melt viscosity of 6000 poise or more, in some examples, a melt viscosity of 8000 poise or more, in some examples, a melt viscosity of 10000 poise or more, in some examples, a melt viscosity of 12000 poise or more. If the polymer resin comprises a plurality of polymers all the polymers of the polymer resin may together form a mixture (excluding any other components of the electrophotographic ink composition) that has a melt viscosity of 6000 poise or more, in some examples, a melt viscosity of 8000 poise or more, in some examples, a melt viscosity of 10000 poise or more, in some examples, a melt viscosity of 12000 poise or more. Melt viscosity can be measured using standard techniques. The melt viscosity can be measured using a rheometer, for example, a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The polymer resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The polymer resin may comprise (i) a first polymer that is a co-polymer of ethylene and an ethylenically unsaturated acid of either acrylic acid or methacrylic acid, wherein the ethylenically unsaturated acid of either acrylic or methacrylic acid constitutes from 8 wt. % to about 16 wt. % of the co-polymer, in some examples, 10 wt. % to 12 wt. % of the co-polymer; and (ii) a second polymer that is a co-polymer of ethylene and an ethylenically unsaturated acid of either acrylic acid or methacrylic acid, wherein the ethylenically unsaturated acid of either acrylic or methacrylic acid constitutes from 10 wt. % to about 30 wt. % of the co-polymer, in some examples, from 12 wt. % to about 20 wt. % of the co-polymer, in some examples, from 14 wt. % to about 19 wt. % of the co-polymer in some examples, from 14 wt. % to 17 wt. % of the co-polymer.

The polymer resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, for example, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbon atoms, in some examples, 1 to 20 carbon atoms, in some examples, 1 to 10 carbon atoms; in some examples, selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples, an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples, 5% to 40% by weight, in some examples, 5% to 20% by weight of the co-polymer, in some examples, 5% to 15% by weight of the co-polymer. The second monomer may constitute 1% to 50% by weight of the co-polymer, in some examples, 5% to 40% by weight of the co-polymer, in some examples, 5% to 20% by weight of the co-polymer, in some examples, 5% to 15% by weight of the co-polymer. In some examples, the first monomer constitutes 5% to 40% by weight of the co-polymer and the second monomer constitutes 5% to 40% by weight of the co-polymer, with the third monomer constituting the remaining weight of the co-polymer. In some examples, the first monomer constitutes 5% to 15% by weight of the co-polymer and the second monomer constitutes 5% to 15% by weight of the co-polymer, with the third monomer constituting the remaining weight of the co-polymer. In some examples, the first monomer constitutes 8% to 12% by weight of the co-polymer and the second monomer constitutes 8% to 12% by weight of the co-polymer, with the third monomer constituting the remaining weight of the co-polymer. In some examples, the first monomer constitutes about 10% by weight of the co-polymer and the second monomer constitutes about 10% by weight of the co-polymer, with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. first thermoplastic resin polymers, in the liquid electrophotographic ink composition and/or the electrostatic ink layer printed on the substrate, e.g. the total amount of the polymer or polymers having acidic side groups and polymer having ester side groups. The polymer having ester side groups may constitute 5% or more by weight of the total amount of the resin polymers, e.g. first thermoplastic resin polymers, in some examples, 8% or more by weight of the total amount of the resin polymers, e.g. first thermoplastic resin polymers, in some examples, 10% or more by weight of the total amount of the resin polymers, e.g. first thermoplastic resin polymers, in some examples, 15% or more by weight of the total amount of the resin polymers, e.g. first thermoplastic resin polymers, in some examples, 20% or more by weight of the total amount of the resin polymers, e.g. first thermoplastic resin polymers, in some examples, 25% or more by weight of the total amount of the resin polymers, e.g. first thermoplastic resin polymers, in some examples, 30% or more by weight of the total amount of the resin polymers, e.g. first thermoplastic resin polymers, in some examples, 35% or more by weight of the total amount of the resin polymers, e.g. first thermoplastic resin polymers, in the liquid electrophotographic composition and/or the electrostatic ink layer printed on the substrate. The polymer having ester side groups may constitute from 5% to 50% by weight of the total amount of the resin polymers, e.g. first thermoplastic resin polymers, in the liquid electrophotographic composition and/or the electrostatic ink layer printed on the substrate, in some examples, 10% to 40% by weight of the total amount of the resin polymers, e.g. first thermoplastic resin polymers, in the liquid electrophotographic composition and/or the electrostatic ink layer printed on the substrate, in some examples, 5% to 30% by weight of the total amount of the resin polymers, e.g. first thermoplastic resin polymers, in the liquid electrophotographic composition and/or the electrostatic ink layer printed on the substrate, in some examples, 5% to 15% by weight of the total amount of the resin polymers, e.g. first thermoplastic resin polymers, in the liquid electrophotographic composition and/or the electrostatic ink layer printed on the substrate, in some examples, 15% to 30% by weight of the total amount of the resin polymers, e.g. first thermoplastic resin polymers, in the liquid electrophotographic composition and/or the electrostatic ink layer printed on the substrate.

The polymer having ester side groups may have an acidity of 50 mg KOH/g or more, in some examples, an acidity of 60 mg KOH/g or more, in some examples, an acidity of 70 mg KOH/g or more, in some examples, an acidity of 80 mg KOH/g or more. The polymer having ester side groups may have an acidity of 100 mg KOH/g or less, in some examples, 90 mg KOH/g or less. The polymer having ester side groups may have an acidity of 60 mg KOH/g to 90 mg KOH/g, in some examples, 70 mg KOH/g to 80 mg KOH/g.

The polymer having ester side groups may have a melt flow rate of about 10 g/10 minutes to about 120 g/10 minutes, in some examples, about 10 g/10 minutes to about 50 g/10 minutes, in some examples, about 20 g/10 minutes to about 40 g/10 minutes, in some examples, about 25 g/10 minutes to about 35 g/10 minutes.

The polymer, polymers, co-polymer or co-polymers of the first thermoplastic resin can, in some examples, be selected from the Nucrel family of resins (e.g. Nucrel 403™ Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX76™, Nucrel 2806™, Bynell 2002, Bynell 2014, Bynell 2020 and Bynell 2022, (sold by E.I. du PONT)), the AC family of resins (e.g. AC-5120, AC-5180, AC-540, AC-580 (sold by Honeywell)), the Aclyn family of resins (e.g. Aclyn 201, Aclyn 246, Aclyn 285, and Aclyn 295), and the Lotader family of resins (e.g. Lotader 2210, Lotader, 3430, and Lotader 8200 (sold by Arkema)).

The polymer resin can constitute about 5% to 90%, in some examples, about 50% to 80%, by weight of the solids of the liquid electrophotographic composition and/or the electrostatic ink layer printed on the substrate. The resin can constitute about 60% to 95%, in some examples, about 70% to 95%, by weight of the solids of the liquid electrophotographic composition and/or the electrostatic ink layer printed on the substrate.

Carrier Liquid

In some examples, an electrostatic ink composition described herein comprises polymer resin coated pigment particles, or polymer resin particles, which are formed in and/or dispersed in a carrier fluid or carrier liquid. Before application to the surface of the substrate, in an electrostatic printing process the electrostatic ink composition may be an electrostatic ink composition, which may be in dry form, for example, in the form of flowable pigment particles coated with the first thermoplastic resin. In some examples, before application to the substrate in an electrostatic printing process, an electrostatic ink composition may be in liquid form; and may comprise a carrier liquid in which is suspended pigment particles coated with the first thermoplastic resin.

Generally, the carrier liquid acts as a reaction solvent in preparing the coated pigment particles, and can also act as a dispersing medium for the other components in the resulting electrostatic ink composition. In some examples, the carrier liquid is a liquid which does not dissolve the polymer resin at room temperature. In some examples, the carrier liquid is a liquid which dissolves the polymer resin at elevated temperatures. For example, the polymer resin may be soluble in the carrier liquid when heated to a temperature of at least 80° C., for example, 90° C., for example, 100° C., for example, 110° C., for example, 120° C. For example, the carrier liquid can comprise or be a hydrocarbon, silicone oil, vegetable oil, etc. The carrier liquid can include an insulating, non-polar, non-aqueous liquid that can be used as a medium for toner particles. The carrier liquid can include compounds that have a resistivity in excess of about 109 ohm·cm. The carrier liquid may have a dielectric constant below about 5, in some examples, below about 3. The carrier liquid can include hydrocarbons. The hydrocarbon can include an aliphatic hydrocarbon, an isomerized aliphatic hydrocarbon, branched chain aliphatic hydrocarbons, aromatic hydrocarbons, and combinations thereof. Examples of the carrier liquids include aliphatic hydrocarbons, isoparaffinic compounds, paraffinic compounds, dearomatized hydrocarbon compounds, and the like. In particular, the carrier liquids can include Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before printing, the carrier liquid can constitute about 20% to 99.5% by weight of an electrostatic ink composition, in some examples, 50% to 99.5% by weight of an electrostatic ink composition. Before printing, the carrier liquid may constitute about 40% to 90% by weight of an electrostatic ink composition. Before printing, the carrier liquid may constitute about 60% to 80% by weight of an electrostatic ink composition. Before printing, the carrier liquid may constitute about 90% to 99.5% by weight of an electrostatic ink composition, in some examples, 95% to 99% by weight of an electrostatic ink composition.

An electrostatic ink composition, when printed on a substrate, that is, the electrostatic ink layer in the printed substrate, may be substantially free from carrier liquid. In an electrostatic printing process and/or afterwards, the carrier liquid may be removed, for example, by an electrophoresis processes during printing and/or evaporation, such that substantially just solids are transferred to the surface of the substrate. Substantially free from carrier liquid may indicate that the ink layer printed on the substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, the ink layer printed on a substrate, that is, the electrostatic ink layer in the printed substrate, is free from carrier liquid.

Charge Director and Charge Adjuvant

A liquid electrophotographic composition and/or the electrostatic ink layer printed on a surface of the substrate can comprise a charge director. A charge director can be added to an electrostatic composition to impart a charge of a desired polarity and/or maintain sufficient electrostatic charge on the particles of an electrostatic ink composition. The charge director may comprise ionic compounds, including, for example, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from oil-soluble petroleum sulfonates (e.g. neutral Calcium Petronate™, neutral Barium Petronate™ and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, for example, barium, sodium, calcium, and aluminium salts of sulfonic acid. The sulfonic acids may include, for example, alkyl sulfonic acids, aryl sulfonic acids, and sulfonic acids of alkyl succinates (e.g. see WO 2007/130069). The charge director can impart a negative charge or a positive charge on the resin-containing particles of an electrostatic ink composition.

The charge director can comprise a sulfosuccinate moiety of the general formula: [Rₐ—O—C(O)CH₂CH(SO₃)C(O)—O—R_{b}], where each of Rₐ and R_{b} is an alkyl group. In some examples, the charge director comprises nanoparticles of a simple salt and a sulfosuccinate salt of the general formula MA_{R}, wherein M is a metal, n is the valence of M, and A is an ion of the general formula [Rₐ—O—C(O)CH₂CH(SO₃)C(O)—O—R_{b}], where each of Rₐ and R_{b} is an alkyl group, or other charge directors as found in WO2007130069, which is incorporated herein by reference in its entirety. As described in WO2007130069, the sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 200 nm or less, in some examples, 2 nm or more. As described in WO2007130069, simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al³⁺, or from any sub-group thereof. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(FO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof. The charge director may further comprise basic barium petronate (BBP).

In the formula [Rₐ—O—C(O)CH₂CH(SO₃)C(O)—O—R_{b}], in some examples, each of Rₐ and R_{b} is an aliphatic alkyl group. In some examples, each of Rₐ and R_{b} independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, Rₐ and R_{b} are the same. In some examples, at least one of Rₐ and R_{b} is C₁₃H₂₇. In some examples, M is Na, K, Cs, Ca, or Ba. The formula [Rₐ—O—C(O)CH₂CH(SO₃)C(O)—O—R_{b}] and/or the formula MAₙ may be as defined in any part of WO2007130069.

The charge director may comprise (i) soya lecithin, (ii) a barium sulfonate salt, such as basic barium petronate (BBP), and (iii) an isopropyl amine sulfonate salt. Basic barium petronate is a barium sulfonate salt of a 21-26 hydrocarbon alkyl, and can be obtained, for example, from Chemtura. An example isopropyl amine sulfonate salt is dodecyl benzene sulfonic acid isopropyl amine, which is available from Croda.

In an electrostatic ink composition, the charge director can constitute about 0.001% to 20%, in some examples, 0.01% to 20% by weight, in some examples, 0.01% to 10% by weight, in some examples, 0.01% to 1% by weight of the solids of an electrostatic ink composition and/or electrostatic ink layer printed on a surface of the substrate. The charge director can constitute about 0.001% to 0.15% by weight of the solids of a liquid electrophotographic ink composition and/or electrostatic ink layer printed on a surface of the substrate, in some examples, 0.001% to 0.15%, in some examples, 0.001% to 0.02% by weight of the solids of a liquid electrophotographic ink composition and/or electrostatic ink layer printed on a surface of the substrate. In some examples, a charge director imparts a negative charge on an electrostatic ink composition. The particle conductivity may range from 50 to 500 pmho/cm, in some examples, from 200-350 pmho/cm.

A liquid electrophotographic ink composition and/or electrostatic ink layer printed on a surface of the substrate can include a charge adjuvant. In some examples, the charge adjuvant may also act as a grinding agent. A charge adjuvant may be present with a charge director, and may be different to the charge director, and act to increase and/or stabilise the charge on particles, e.g. resin-containing particles, of an electrostatic composition. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmitate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di- and/or tristearate and/or aluminium di- and/or tripalmitate.

The charge adjuvant can constitute about 0.1% to 5% by weight of the solids of a liquid electrophotographic ink composition and/or electrostatic ink layer printed on a surface of the substrate. The charge adjuvant can constitute about 0.5% to 4% by weight of the solids of a liquid electrophotographic ink composition and/or electrostatic ink layer printed on a surface of the substrate. The charge adjuvant can constitute about 1% to 3% by weight of the solids of a liquid electrophotographic ink composition and/or electrostatic ink layer printed on a surface of the substrate.

Other Additives

In some examples, an electrostatic ink composition may include an additive or a plurality of additives. The additive or plurality of additives may be added at any stage of the method. The additive or plurality of additives may be selected from a surfactant, biocides, organic solvents, viscosity modifiers, materials for pH adjustment, sequestering agents, preservatives, compatibility additives, emulsifiers and the like.

Electrostatic Overcoat Composition

In some examples, the electrostatic overcoat composition may comprise a thermoplastic resin and a wax. The thermoplastic resin of the overcoat composition may be referred to as a second thermoplastic resin in order to distinguish it from the thermoplastic resin of the electrostatic ink composition.

In some examples, the electrostatic overcoat composition may comprise a thermoplastic resin, a wax and a charge director. In some examples, the electrostatic overcoat composition may comprise a thermoplastic resin, a wax and a charge adjuvant. In some examples, the electrostatic overcoat composition may comprise a thermoplastic resin, a wax, a charge director and a charge adjuvant. In some examples, the electrostatic overcoat composition may comprise a thermoplastic resin, a wax and a carrier liquid. In some examples, the electrostatic overcoat composition may comprise a thermoplastic resin, a wax, a charge director and a carrier liquid. In some examples, the electrostatic overcoat composition may comprise a thermoplastic resin, a wax, a charge director, a charge adjuvant and a carrier liquid. In some examples, the electrostatic overcoat composition may comprise a thermoplastic resin, a wax and an additive or a plurality of additives. In some examples, the electrostatic overcoat composition may comprise a thermoplastic resin, a wax, a charge director and an additive or a plurality of additives. In some examples, the electrostatic overcoat composition may comprise a thermoplastic resin, a wax, a charge director, a charge adjuvant and an additive or a plurality of additives. In some examples, the electrostatic overcoat composition may comprise a thermoplastic resin, a wax, a charge director, a charge adjuvant, a carrier liquid and an additive or a plurality of additives. In some examples, the charge director, charge adjuvant, carrier liquid and/or additive or plurality of additives used in the electrostatic overcoat composition may be selected from the aforementioned components described for the electrostatic ink composition.

In some examples, the electrostatic overcoat composition is transparent. In some examples, the electrostatic overcoat composition is colourless. In some examples, the electrostatic overcoat composition is transparent and colourless. In some examples, the electrostatic overcoat composition is considered to be transparent and colourless if it is invisible to the human eye once electrostatically printed. In some examples, the electrostatic overcoat composition does not contain any pigment or substantially lacks pigment and thus is a pigment-free composition or a substantially pigment-free composition. The electrostatic overcoat composition may comprise less than 5 wt. % solids of colorant, in some examples, less than 3 wt. % solids of colorant, in some examples, less than 1 wt. % solids of colorant. “Colorant” may, in this context, be a material that imparts colour to the electrostatic overcoat composition and thus may include pigments and dyes, such as those that impart colours such as cyan, magenta, yellow, black and white to a composition. As used herein, “pigment” generally includes pigment colourants, magnetic particles, aluminas, silicas, and/or other ceramics or organometallics. Thus, though the present description primarily exemplifies the use of pigment colourants, the term “pigment” can be used more generally to describe not only pigment colourants, but also other pigments such as organometallics, ferrites, ceramics, and so forth.

In some examples, the second thermoplastic resin may be the same or different from the first thermoplastic resin. In some examples, the second thermoplastic resin may be different from the first thermoplastic resin but may be selected from the aforementioned resins described as first thermoplastic resins. In some examples, the second thermoplastic resin is the same as the first thermoplastic resin.

In some examples, the second thermoplastic resin comprises a polymer having acidic side groups. In some examples, the second thermoplastic resin comprises a copolymer of an alkylene monomer and a monomer selected from acrylic acid or methacrylic acid. In some examples, the second thermoplastic resin comprises a copolymer of ethylene and a monomer selected from acrylic acid or methacrylic acid. In some examples, the second thermoplastic resin comprises two different polymers having acidic side groups. The ratio of the first polymer having acidic side groups to the second polymer having acidic side groups can be from about 10:1 to about 2:1. The ratio can be from about 6:1 to about 3:1, in some examples, about 4:1.

In some examples, the second thermoplastic resin can constitute 1 wt. % or more of the solids of an electrostatic overcoat composition and/or overcoat layer disposed on an electrostatic ink layer, in some examples, 2 wt. % or more of the solids, in some examples, 3 wt. % or more of the solids, in some examples, 4 wt. % or more of the solids, in some examples, 5 wt. % or more of the solids, in some examples, 6 wt. % or more of the solids, in some examples, 7 wt. % or more of the solids, in some examples, 8 wt. % or more of the solids, in some examples, 9 wt. % or more of the solids, in some examples, 10 wt. % or more of the solids, in some examples, 15 wt. % or more of the solids, in some examples, 20 wt. % or more of the solids, in some examples, 25 wt. % or more of the solids, in some examples, 30 wt. % or more of the solids, in some examples, 35 wt. % or more of the solids, in some examples, 40 wt. % or more of the solids, in some examples, 45 wt. % or more of the solids, in some examples, 50 wt. % or more of the solids, in some examples, 55 wt. % or more of the solids, in some examples, 60 wt. % or more of the solids, in some examples, 65 wt. % or more of the solids, in some examples, 70 wt. % or more of the solids, in some examples, 75 wt. % or more of the solids, in some examples, 80 wt. % or more of the solids, in some examples, 85 wt. % or more of the solids, in some examples, 90 wt. % or more of the solids, in some examples, 91 wt. % or more of the solids 92 wt. % or more of the solids, in some examples, 93 wt. % or more of the solids, in some examples, 94 wt. % or more of the solids, in some examples, 95 wt. % or more of the solids of an electrostatic overcoat composition and/or overcoat layer disposed on an electrostatic ink layer. In some examples, the second thermoplastic resin can constitute 95 wt. % or less of the solids of an electrostatic overcoat composition and/or overcoat layer disposed on an electrostatic ink layer, in some examples, 94 wt. % or less of the solids, in some examples, 93 wt. % or less of the solids, in some examples, 92 wt. % or less of the solids, in some examples, 91 wt. % or less of the solids, in some examples, 90 wt. % or less of the solids, in some examples, 85 wt. % or less of the solids, in some examples, 80 wt. % or less of the solids, in some examples, 75 wt. % or less of the solids, in some examples, 70 wt. % or less of the solids, in some examples, 65 wt. % or less of the solids, in some examples, 60 wt. % or less of the solids, in some examples, 55 wt. % or less of the solids, in some examples, 50 wt. % or less of the solids, in some examples, 45 wt. % or less of the solids, in some examples, 40 wt. % or less of the solids, in some examples, 35 wt. % or less of the solids, in some examples, 30 wt. % or less of the solids, in some examples, 25 wt. % or less of the solids, in some examples, 20 wt. % or less of the solids, in some examples, 15 wt. % or less of the solids, in some examples, 10 wt. % or less of the solids, in some examples, 9 wt. % or less of the solids, in some examples, 8 wt. % or less of the solids, in some examples, 7 wt. % or less of the solids, in some examples, 6 wt. % or less of the solids, in some examples, 5 wt. % or less of the solids, in some examples, 4 wt. % or less of the solids, in some examples, 3 wt. % or less of the solids, in some examples, 2 wt. % or less of the solids, in some examples, 1 wt. % or less of the solids of an electrostatic overcoat composition and/or overcoat layer disposed on an electrostatic ink layer. In some examples, the second thermoplastic resin can constitute 1 wt. % to 95 wt. % of the solids of an electrostatic overcoat composition and/or overcoat layer disposed on an electrostatic ink layer, in some examples, 2 wt. % to 94 wt. % of the solids, in some examples, 3 wt. % to 93 wt. % of the solids, in some examples, 4 wt. % to 92 wt. % of the solids, in some examples, 5 wt. % to 91 wt. % of the solids, in some examples, 6 wt. % to 90 wt. % of the solids, in some examples, 7 wt. % to 85 wt. % of the solids, in some examples, 8 wt. % to 80 wt. % of the solids, in some examples, 9 wt. % to 75 wt. % of the solids, in some examples, 10 wt. % to 70 wt. % of the solids, in some examples, 15 wt. % to 65 wt. % of the solids, in some examples, 20 wt. % to 60 wt. % of the solids, in some examples, 25 wt. % to 55 wt. % of the solids, in some examples, 30 wt. % to 50 wt. % of the solids, in some examples, 35 wt. % to 45 wt. % of the solids, in some examples, 40 wt. % to 45 wt. % of the solids of an electrostatic overcoat composition and/or overcoat layer disposed on an electrostatic ink layer.

In some examples, the charge adjuvant can constitute about 0.1% to 5% by weight of the solids of an electrostatic overcoat composition and/or overcoat layer disposed on an electrostatic ink layer. The charge adjuvant can constitute about 0.5% to 4% by weight of the solids of an electrostatic overcoat composition and/or overcoat layer disposed on an electrostatic ink layer. The charge adjuvant can constitute about 1% to 3% by weight of the solids of an electrostatic overcoat composition and/or overcoat layer disposed on an electrostatic ink layer.

In some examples, the charge director can constitute about 0.001% to 20%, in some examples, 0.01% to 20% by weight, in some examples, 0.01% to 10% by weight, in some examples, 0.01% to 1% by weight of the solids of an electrostatic overcoat composition and/or overcoat layer disposed on an electrostatic ink layer. The charge director can constitute about 0.001% to 0.15% by weight of the solids of an electrostatic overcoat composition and/or overcoat layer disposed on an electrostatic ink layer, in some examples, 0.001% to 0.15%, in some examples, 0.001% to 0.02% by weight of the solids of an electrostatic overcoat composition and/or overcoat layer disposed on an electrostatic ink layer. In some examples, a charge director imparts a negative charge on an electrostatic overcoat composition. The particle conductivity may range from 50 to 500 pmho/cm, in some examples, from 200-350 pmho/cm.

Before printing, the carrier liquid can constitute about 20% to 99.5% by weight of an electrostatic overcoat composition, in some examples, 50% to 99.5% by weight of an electrostatic overcoat composition. Before printing, the carrier liquid may constitute about 40% to 90% by weight of an electrostatic overcoat composition. Before printing, the carrier liquid may constitute about 60% to 80% by weight of an electrostatic overcoat composition. Before printing, the carrier liquid may constitute about 90% to 99.5% by weight of an electrostatic overcoat composition, in some examples, 95% to 99% by weight of an electrostatic overcoat composition.

An electrostatic overcoat composition, when printed on a printed substrate, that is, the overcoat layer disposed on the electrostatic ink layer, may be substantially free from carrier liquid. In an electrostatic printing process and/or afterwards, the carrier liquid may be removed, for example, by an electrophoresis processes during printing and/or evaporation, such that substantially just solids are transferred to the printed substrate. Substantially free from carrier liquid may indicate that the overcoat layer printed on the printed substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, the overcoat layer printed on a printed substrate is free from carrier liquid.

Wax

In some examples, the wax constitutes at least 5 wt. % of the solids of the electrostatic overcoat composition, in some examples, at least 10 wt. % of the solids, in some examples, at least 15 wt. % of the solids, in some examples, at least 20 wt. % of the solids, in some examples, at least 25 wt. % of the solids, in some examples, at least 30 wt. % of the solids, in some examples, at least 35 wt. % of the solids, in some examples, at least 40 wt. % of the solids, in some examples, at least 45 wt. % of the solids, in some examples, at least 50 wt. % of the solids, in some examples, at least 55 wt. % of the solids, in some examples, at least 60 wt. % of the solids, in some examples, at least 65 wt. % of the solids, in some examples, at least 70 wt. % of the solids, in some examples, at least 75 wt. % of the solids, in some examples, at least 80 wt. % of the solids, in some examples, at least 85 wt. % of the solids, in some examples, at least 90 wt. % of the solids, in some examples, at least 95 wt. % of the solids, in some examples, at least 96 wt. % of the solids, in some examples, about 97 wt. % of the solids of the electrostatic overcoat composition.

In some examples, the wax constitutes 97 wt. % or less of the solids of the electrostatic overcoat composition, in some examples, 96 wt. % or less of the solids, in some examples, 95 wt. % or less of the solids, in some examples, 90 wt. % or less of the solids, 85 wt. % or less of the solids, in some examples, 80 wt. % or less of the solids, in some examples, 75 wt. % or less of the solids, in some examples, 70 wt. % or less of the solids, in some examples, 65 wt. % or less of the solids, in some examples, 60 wt. % or less of the solids, in some examples, 55 wt. % or less of the solids, in some examples, 50 wt. % or less of the solids, in some examples, 45 wt. % or less of the solids, in some examples, 40 wt. % or less of the solids, in some examples, 35 wt. % or less of the solids, in some examples, 30 wt. % or less of the solids, in some examples, 25 wt. % or less of the solids, in some examples, 20 wt. % or less of the solids, in some examples, 15 wt. % or less of the solids, in some examples, 10 wt. % or less of the solids, in some examples, about 5 wt. % of the solids of the electrostatic overcoat composition.

In some examples, the wax constitutes 5 wt. % to 97 wt. % of the solids of the electrostatic overcoat composition, in some examples, 10 wt. % to 96 wt. % of the solids, in some examples, 15 wt. % to 95 wt. % of the solids, in some examples, 20 wt. % to 90 wt. % of the solids, in some examples, 25 wt. % to 85 wt. % of the solids, in some examples, 30 wt. % to 80 wt. % of the solids, in some examples, 35 wt. % to 75 wt. % of the solids, in some examples, 40 wt. % to 70 wt. % of the solids, in some examples, 45 wt. % to 65 wt. % of the solids, in some examples, 50 wt. % to 60 wt. % of the solids, in some examples, 55 wt. % to 60 wt. % of the solids of the electrostatic overcoat composition.

In some examples, the wax may be a natural wax or a synthetic wax. In some examples, the wax may be selected from vegetable wax, mineral wax, petroleum wax, paraffin wax, microcrystalline wax, synthetic Fischer-Tropsch waxes, and amide-modified wax.

In some examples, vegetable waxes, mineral waxes and petroleum waxes comprise organic compounds having hydrophobic properties. In some examples, vegetable waxes, mineral waxes and petroleum waxes are esters of long-chain acids, which may comprise between 40 and 50 carbon atoms. In some examples, the natural wax may be castor oil or hydrogenated castor oil. In some examples, paraffin waxes may comprise linear hydrocarbon chains, which may comprise between 25 and 50 carbon atoms. In some examples, microcrystalline waxes may comprise branched chain hydrocarbons, which may comprise between 70 and 90 carbon atoms. In some examples, synthetic Fischer-Tropsch waxes may comprise linear hydrocarbon chains, which may have a higher weight average molecular weight than paraffin waxes. In some examples, Fischer-Tropsch waxes may comprise linear hydrocarbon chains, which may have at least 50 carbon atoms, in some examples, from 50 to 90 carbon atoms. In some examples, amide-modified waxes are primary amides formed from the reaction of a diaminoalkylene with a long-chain acid or a fatty acid. In some examples, amide-modified waxes are primary amides formed from the reaction of 1,2-diaminoethane with a long chain acid or fatty acid. In some examples, the amide-modified wax may be ethylene bis(stearamide) or erucamide.

In some examples, the wax may be selected from fatty acid esters, fatty acid amides and hydrocarbons.

In some examples, the hydrocarbon may comprise at least 25 carbon atoms, in some examples, at least 30 carbon atoms, in some examples at least 35 carbon atoms, in some examples, at least 40 carbon atoms, in some examples, at least 45 carbon atoms, in some examples, at least 50 carbon atoms, in some examples, at least 55 carbon atoms, in some examples, at least 60 carbon atoms, in some examples, at least 65 carbon atoms, in some examples, at least 70 carbon atoms, in some examples, at least 75 carbon atoms, in some examples, at least 80 carbon atoms, in some examples, at least 85 carbon atoms, in some examples, at least 90 carbon atoms.

In some examples, the hydrocarbon may be a linear hydrocarbon, a branched hydrocarbon or a cyclic hydrocarbon. In some examples, the hydrocarbon may be a linear hydrocarbon comprising at least 25 carbon atoms. In some examples, the hydrocarbon may be a linear hydrocarbon comprising 25 to 100 carbon atoms, in some examples, 30 to 95 carbon atoms, in some examples, 35 to 90 carbon atoms, in some examples, 40 to 85 carbon atoms, in some examples, 45 to 80 carbon atoms, in some examples, 50 to 75 carbon atoms, in some examples, 55 to 70 carbon atoms, in some examples, 60 to 65 carbon atoms. In some examples, the hydrocarbon may be a branched hydrocarbon comprising at least 25 carbon atoms. In some examples, the hydrocarbon may be a branched chain hydrocarbon comprising at least 70 carbon atoms, in some examples, 70 to 90 carbon atoms, in some examples, 75 to 85 carbon atoms, in some examples, 80 to 85 carbon atoms.

In some examples, the wax is selected from fatty acid esters and fatty acid amides. In some examples, the fatty acid ester or fatty acid amide comprises or is derived from a saturated fatty acid, an unsaturated fatty acid, a straight-chain fatty acid, a branched chain fatty acid, a cyclic fatty acid or a mixture thereof. In some examples, the fatty acid ester is producible by esterification of a saturated fatty acid, an unsaturated fatty acid, a straight-chain fatty acid, a branched chain fatty acid, a cyclic fatty acid or a mixture thereof. In some examples, the fatty acid amide is producible by amidation of a saturated fatty acid, an unsaturated fatty acid, a straight-chain fatty acid, a branched chain fatty acid, a cyclic fatty acid or a mixture thereof.

In some examples, the wax may comprise a mixture of fatty acid esters and/or a mixture of fatty acid amides and/or a mixture of fatty acid esters and fatty acid amides. In some examples, the mixture of fatty acid esters may be derived from a vegetable oil, for example, castor oil.

In some examples, the fatty acid ester or fatty acid amide comprises at least one carbon chain comprising 4 to 40 carbon atoms, in some examples, 4 to 28 carbon atoms, in some examples, 6 to 26 carbon atoms, in some examples, 10 to 24 carbon atoms, in some examples, 12 to 20 carbon atoms, in some examples, 14 to 20 carbon atoms.

In some examples, the fatty acid ester or fatty acid amide may comprise or be derived from (e.g., formed by esterification or amidation of) saturated or unsaturated fatty acids, that is, the fatty acid ester or fatty acid amide comprises a saturated or unsaturated carbon chain. In some examples, the fatty acid ester or fatty acid amide may comprise or be derived from (e.g., formed by esterification or amidation of) saturated fatty acids, that is, comprise a saturated carbon chain. In some examples, the fatty acid ester or fatty acid amide may comprise or be derived from (e.g., formed by esterification or amidation of) unsaturated fatty acids, that is, comprise an unsaturated carbon chain.

In some examples, the fatty acid ester or fatty acid amide may comprise or be derived from (e.g., formed by esterification or amidation of) straight-chain, branched or cyclic fatty acids, that is, have a straight, branched or cyclic carbon chain. In some examples, the fatty acid ester or fatty acid amide may comprise or be derived from (e.g., formed by esterification or amidation of) straight-chain or branched fatty acids. In some examples, the fatty acid ester or fatty acid amide may comprise or be derived from (e.g., formed by esterification or amidation of) straight-chain fatty acids.

In some examples, the fatty acid ester is producible by esterification of at least one fatty acid with an alcohol. In some examples, the fatty acid ester is producible by esterification of a plurality of fatty acids with a polyol. In some examples, the fatty acid ester is producible by esterification of at least two fatty acids with an alcohol having at least two alcoholic groups. In some examples, the fatty acid ester is producible by esterification of three fatty acids with an alcohol having at least three alcoholic groups. In some examples, the fatty acid ester is producible by esterification of a fatty acid with an alcohol.

In some examples, the fatty acid ester may comprise or be derived from a plurality of fatty acids, which may be the same or different. In other words, each fatty acid ester molecule can contain at least two different types of carbon chain, each of which is derived from a different fatty acid.

In some examples, the fatty acid ester may be a glyceride, optionally a monoglyceride, a diglyceride or a triglyceride. In some examples, the fatty acid ester is a di- or triglyceride. In some examples, the fatty acid ester is a triglyceride.

In some examples, the fatty acid amide is producible by amidation of at least one fatty acid with ammonium or an amino alkane having at least one amine group. In some examples, the fatty acid amide is producible by amidation of a plurality of fatty acids with a polyamino alkane. In some examples, the fatty acid amide is producible by amidation of at least two fatty acids with an amine having at least two amino groups. In some examples, the fatty acid amide is producible by amidation of three fatty acids with an amine having at least three amine groups. In some examples, the fatty acid amide is producible by amidation of one fatty acid with ammonium or an amino alkane, which may be an amino alkane having one amine group.

In some examples, the fatty acid amide may comprise or be derived from a plurality of fatty acids, which may be the same or different. In other words, each fatty acid amide molecule can contain at least two different types of carbon chain, each of which is derived from a different fatty acid.

In some examples, the amine may be selected from ammonium, an amino alkane (a mono-amino alkane), a diamino alkane, a triamino alkane, an amino alkene (a mono-amino alkene), a diamino alkene, a triamino alkene. In some examples, the amine may comprise a straight chain alkane, a branched chain alkane, a cyclic alkane or a mixture thereof. In some examples, the amine may comprise a saturated or unsaturated alkane. In some examples, the amine may be selected from ammonium, methylamine, diaminomethane, ethylamine, diaminoethane (e.g., 1,1-diaminoethane or 1,2-diaminoethane), propylamine, diaminopropane (e.g., 1,1-diaminopropane, 1,2-diaminopropane, or 1,3-diaminopropane), triaminopropane (e.g., 1,2,3-triamino-propane), butylamine, diaminobutane (e.g., 1,1-diaminobutane, 1,2-diaminobutane, 1,3-diaminobutane, or 1,4-diaminobutane) and triaminobutane (e.g., 1,2,3-triaminobutane, or 1,2,4-triaminobutane). In some examples, the fatty acid amide may be an ethylenebis(amide).

In some examples, the fatty acid amide is selected from fatty acid primary amides, fatty acid secondary amides and fatty acid tertiary amides. In some examples, the fatty acid amide is a fatty acid primary amide. In some examples, the fatty acid primary amide is selected from saturated fatty acid primary amides and unsaturated fatty acid primary amides. In some examples, the fatty acid primary amide is an unsaturated fatty acid primary amide.

In some examples, the fatty acid may be a substituted fatty acid. In some examples, the substituted fatty acid may be selected from hydroxyl-substituted fatty acids, amino-substituted fatty acids, epoxy-substituted fatty acids and heteroatom-substituted fatty acids. In some examples, the fatty acid may be a hydroxyl-substituted fatty acid.

In some examples, the fatty acid ester or fatty acid amide may comprise a plurality of substituents. In some examples, the fatty acid ester or fatty acid amide may comprise a plurality of substituents selected from hydroxyl substituents, amino substituents, epoxy substituents and heteroatom substituents. In some examples, the fatty acid ester may comprise a plurality of hydroxyl substituents. In some examples, the fatty acid amide may comprise a plurality of hydroxyl substituents. In some examples, the fatty acid ester or fatty acid amide may comprise a carbon chain having a plurality of substituents, for example, a plurality of hydroxyl substituents. In some examples, the fatty acid ester or fatty acid amide may comprise a plurality of carbon chains, at least two of which has at least one substituent.

In some examples, the fatty acid ester is a mono-, di- or triglyceride and each of the fatty acid chains (i.e., the carbon chains of the fatty acid) on the same molecule may be the same or different. In some examples, the fatty acid amide is derived from a polyamine, for example, a diamine or a triamine, and each of the fatty acid chains (i.e., the carbon chains of the fatty acid) on the same molecule may be the same or different.

In some examples, the fatty acid amide may be selected from oleamide, erucamide, linoleamide, and mixtures thereof.

In some examples, the fatty acid amide may be selected from stearami-doethylstearamide, stearamidoethylpalmitamide, palmitamidoethylstearamide, ethyl-enebisstearamide, ethylenebisoleamide, stearylerucamide, erucamidoethylerucamide, oleamidoethyloleamide, erucamidoethyloleamide, oleamidoethylerucamide, stearami-doethylerucamide, erucamidoethylpalmitamide, palmitamidoethyl-oleamide and erucamide. Examples of commercially available amide-modified waxes include Finawax C, Finawax VL and Finawax E, all of which are available from Fine Organics, India.

In some examples, the fatty acid ester may be a castor oil derivative, for example, a hydrogenated castor oil.

In some examples, the fatty acid ester may comprise an esterified fatty acid, wherein the fatty acid is selected from caprylic acid, capric acid, lauric acid, myristic acid, palmitic acid, stearic acid, arachidic acid, behenic acid, cerotic acid; and, in some examples, the esterified fatty acid may be a monoglyceride, a diglyceride or a triglyceride, that is, the ester of glycerol and one of the fatty acids, the ester of glycerol and two of the fatty acids or the ester of glycerol and three of the fatty acids, respectively. In some examples, the fatty acid ester may comprise an esterified fatty acid, wherein the fatty acid is selected from hydroxycaprylic acid, hydroxycapric acid, hydroxylauric acid, hydroxymyristic acid, hydroxypalmitic acid, hydroxystearic acid, hydroxyarachidic acid, hydroxybehenic acid, hydroxycerotic acid; and, in some examples, the esterified fatty acid may be a monoglyceride, a diglyceride or a triglyceride, that is, the ester of glycerol and one of the fatty acids, the ester of glycerol and two of the fatty acids or the ester of glycerol and three of the fatty acids, respectively.

In some examples, the fatty acid ester may comprise an ester of a fatty acid selected from ricinoleic acid, 12-hydroxystearic acid (i.e., hydrogenated ricinoleic acid), 10-hydroxystearic acid, 3-hydroxystearic acid, 12-hydrocylauric acid, 16-hydroxypalmitic acid, 2-hydrocypalmitic acid or 3-hydroxypalmitic acid, and, in some examples, the esterified fatty acid may be a monoglyceride, a diglyceride or a triglyceride, that is, the ester of glycerol and one of the fatty acids, ester of glycerol and two of the fatty acids or the ester of glycerol and three of the fatty acids, respectively.

In some examples, the fatty acid ester may comprise an esterified saturated hydroxyl fatty acid, wherein the hydroxyl fatty acid may be selected from 2-hydroxyvaleric acid, 2-hydroxycaproic acid, 6-hydroxycaproic acid, 2-hydroxyenanthic acid, 7-hydroxyenanthic acid, 2-hydroxycaprylic acid, 3-hydroxycaprylic acid, 8-hydroxycaprylic acid, 2-hydroxypelargonic acid, 3-hydroxypelargonic acid, 9-hydroxypelargonic acid, 2-hydroxycapric acid, 3-hydroxycapric acid, 10-hydroxycapric acid, 2-hydroxyundecanoic acid, 3-hydroxyundecanoic acid, 11-hydroxyundecanoic acid, 2-hydroxylauric acid, 3-hydroxylauric acid, 12-hydroxylauric acid, 2-hydroxytridecanoic acid, 3-hydroxytridecanoic acid, 13-hydroxytridecanoic acid, 2-hydroxymyristic acid, 3-hydroxymyristic acid, 14-hydroxymyristic acid, 2-hydroxypentadecanoic acid, 3-hydroxypentadecanoic acid, 15-hydroxypentadecanoic acid, 2-hydroxypalmitic acid, 3-hydroxypalmitic acid, 16-hydroxypalmitic acid, 2-hydroxymargaric acid, 3-hydroxymargaric acid, 17-hydroxymargaric acid, 2-hydroxystearic acid, 3-hydroxystearic acid, 4-hydroxystearic acid, 5-hydroxystearic acid, 6-hydroxystearic acid, 7-hydroxystearic acid, 8-hydroxystearic acid, 9-hydroxystearic acid, 10-hydroxystearic acid, 11-hydroxystearic acid, 12-hydroxystearic acid, 13-hydroxystearic acid, 14-hydroxystearic acid, 15-hydroxystearic acid, 16-hydroxystearic acid, 17-hydroxystearic acid, 18-hydroxystearic acid, 2-hydroxynonadecanoic acid, 3-hydroxynonadecanoic acid, 19-hydroxynonadecanoic acid, 2-hydroxyarachic acid, 3-hydroxyarachic acid, 20-hydroxyarachic acid, 3-hydroxyheneicosanoic acid, 21-hydroxyheneicosanoic acid, 2-hydroxybehenic acid, 3-hydroxybehenic acid, 3-hydroxytricosanoic acid, 2-hydroxylignoceric acid, 3-hydroxylignoceric acid, 2-hydroxyhexacosanoic acid, 2-hydroxytriacontanoic acid, 2-hydroxytetratriacontanoic acid, 2-methyl-2-hydroxyenanthic acid, 2-methyl-3-hydroxypelargonic acid, 3-methyl-3-hydroxypelargonic acid, 2-methyl-3-hydroxycapric acid, 2-methyl-3-hydroxyundecanoic acid, 3-methyl-3-hydroxyundecanoic acid, 2-methyl-2-hydroxylauric acid, 2-methyl-3-hydroxylauric acid, 2-methyl-2-hydroxytridecanoic acid, 2-methyl-3-hydroxytridecanoic acid, 3-methyl-3-hydroxytridecanoic acid, 2-methyl-2-hydroxymyristic acid, 2-methyl-3-hydroxymyristic acid, 2-methyl-2-hydroxypentadecanoic acid, 2-methyl-3-hydroxypentadecanoic acid, 3-methyl-3-hydroxypentadecanoic acid, 2-methyl-2-hydroxypalmitic acid, 2-methyl-2-hydroxymargaric acid, 2-methyl-3-hydroxymargaric acid, 3-methyl-3-hydroxymargaric acid, 2-methyl-2-hydroxystearic acid, 2-methyl-2-hydroxynonadecanoic acid, 2-methyl-2-hydroxynonadecanoic acid, and 3-methyl-3-hydroxynonadecanoic acid, and, in some examples, the esterified fatty acid may be a monoglyceride, a diglyceride or a triglyceride, i.e. the ester of glycerol and one of the fatty acids, the ester of glycerol and two of the fatty acids or the ester of glycerol and three of the fatty acids, respectively.

In some examples, the fatty acid ester may comprise a vegetable oil or a hydrogenated vegetable oil. In some examples, the fatty acid ester may be selected from castor oil, lesquerella oil, cosmos oil, and hydrogenated oils thereof. In some examples, the fatty acid ester may comprise a hydrogenated castor oil.

In some examples, the fatty acid amide may be a primary amide, a secondary amide or a tertiary amide. In some examples, the fatty acid amide may be a secondary amide or a primary amide. In some examples, the fatty acid amide may be a primary amide. In some examples, the fatty acid amide may be a ceramide.

The fatty acid amide may be the reaction product resulting from the reaction between a fatty acid ester, such as a hydrogenated castor oil, and an amine, such as an aliphatic diamine, which may be selected from 1,2-ethanediamine, 1,3-propanediamine and 1,6-hexanediamine.

Ink Set

In some examples, there is provided an ink set. The ink set may comprise:
an electrostatic ink composition comprising a first thermoplastic resin and a pigment; and
an electrostatic overcoat composition comprising a second thermoplastic resin and a wax, wherein the wax constitutes at least 5 wt. % of the solids of the electrostatic overcoat composition.

In some examples, the electrostatic ink composition may be as described previously. In some examples, the electrostatic overcoat composition may be as described previously.

Process for Preparing a Printed Product

In some examples, the process for preparing a printed product comprises providing a printed substrate comprising an electrostatic ink layer on a surface of a substrate and electrostatically printing an electrostatic overcoat composition onto the printed substrate. In some examples, the process for preparing a printed product comprises providing a printed substrate comprising an electrostatic ink layer on a surface of a substrate and electrostatically printing an electrostatic overcoat composition onto the printed substrate, the electrostatic overcoat composition comprising a second thermoplastic resin and a wax. In some examples, the process for preparing a printed product comprises providing a printed substrate comprising an electrostatic ink layer on a surface of a substrate, the electrostatic ink layer comprising a first thermoplastic resin and a pigment; and electrostatically printing an electrostatic overcoat composition onto the printed substrate, the electrostatic overcoat composition comprising a second thermoplastic resin.

In some examples, the process comprises electrostatically printing an overcoat composition onto the printed substrate with an electrostatic printer. In some examples, the process comprises electrostatically printing an overcoat composition onto the printed substrate with a liquid electrostatic printer. Non-limiting examples of electrostatic printing apparatuses suitable for use with the processes described herein include the HP Indigo printing presses.

Electrostatically printing an overcoat composition onto the printed substrate may comprise a standard electrostatic printing process and be performed on an electrostatic printing apparatus. Electrostatically printing an overcoat composition may involve creating an image on a photoconductive surface, applying the overcoat composition having charged particles comprising the thermoplastic resin and the wax to the photoconductive surface, such that the charged particles selectively bind to the image, and then transferring the charged particles in the form of the image to the printed substrate.

The photoconductive surface may be on a cylinder and may be a photo-imaging plate (PIP). The photoconductive surface may be selectively charged with a latent electrostatic image having image and background areas with different potentials. For example, the electrostatic overcoat composition comprising charged particles comprising a thermoplastic resin and a wax may be brought into contact with the selectively charged photoconductive surface. The charged particles comprising the thermoplastic resin and the wax adhere to the image areas of the latent electrostatic image while the background areas remain clean. The image is then transferred to the printed substrate directly or, in some examples, by being first transferred to an intermediate transfer member, which can be a soft swelling blanket, which may be heated to fuse the solid image and, in some examples, evaporate the carrier liquid, and then to the printed substrate.

In some examples, the electrostatic overcoat composition is electrostatically printed over the entire surface of the printed substrate. In some examples, the electrostatic overcoat composition is electrostatically printed over only a portion of the printed substrate, for example the portions of the printed substrate covered by the electrostatic ink layer.

In some examples, a printed substrate is provided by electrostatically printing an ink layer on a surface of a substrate. In some examples, electrostatically printing an ink layer on a surface of a substrate comprises liquid electrostatically printing an ink layer on a surface of a substrate.

In some examples, a printed substrate is provided by electrostatically printing an ink layer on a surface of a substrate with an electrostatic printer. In some examples, a printed substrate is provided by liquid electrostatically printing an ink layer on a surface of a substrate with a liquid electrostatic printer.

Electrostatically printing an ink layer onto a substrate may comprise a standard electrostatic printing process and be performed on an electrostatic printing apparatus Electrostatically printing an ink layer on a surface of a substrate may involve creating an image on a photoconductive surface, applying the electrostatic ink composition having charged particles comprising the first thermoplastic resin and the pigment to the photoconductive surface, such that the charged particles selectively bind to the image, and then transferring the charged particles in the form of the image to the surface of the substrate.

The photoconductive surface may be on a cylinder and may be a photo-imaging plate (PIP). The photoconductive surface may be selectively charged with a latent electrostatic image having image and background areas with different potentials. For example, the electrostatic ink composition comprising charged particles comprising a first thermoplastic resin and a pigment may be brought into contact with the selectively charged photoconductive surface. The charged particles comprising the first thermoplastic resin and the pigment adhere to the image areas of the latent electrostatic image while the background areas remain clean. The image is then transferred to the surface of the substrate directly or, in some examples, by being first transferred to an intermediate transfer member, which can be a soft swelling blanket, which may be heated to fuse the solid image and, in some examples, evaporate the carrier liquid, and then to the surface of the substrate.

In some examples, electrostatically printing an ink layer on a surface of a substrate with an electrostatic printer may involve electrostatically printing several electrostatic ink compositions comprising different pigments onto the surface of the substrate. In some examples, electrostatically printing an ink layer on a surface of a substrate may comprise printing one or more inks on selected regions of the substrate.

In some examples, the process for preparing a printed product comprises electrostatically printing an ink layer on a surface of a substrate to provide a printed substrate comprising an electrostatic ink layer on a surface of a substrate, the electrostatic ink layer comprising a first thermoplastic resin and a pigment; and electrostatically printing an electrostatic overcoat composition onto the printed substrate, the electrostatic overcoat composition comprising a second thermoplastic resin.

In some examples, both electrostatically printing an ink layer and electrostatically printing an electrostatic overcoat layer involve use of the same electrostatic printer, for example, the same liquid electrostatic printer.

In some examples, an ink layer is electrostatically printed on a surface of a substrate by creating an image on a photoconductive surface, applying the electrostatic ink composition having charged particles comprising the first thermoplastic resin and the pigment to the photoconductive surface, such that the charged particles selectively bind to the image, and then transferring the charged particles in the form of the image to the surface of the substrate to form a printed substrate and then an electrostatic overcoat layer is electrostatically printed on the printed substrate by creating an image on a photoconductive surface, applying the overcoat composition having charged particles comprising the thermoplastic resin and the wax to the photoconductive surface, such that the charged particles selectively bind to the image, and then transferring the charged particles in the form of the image to the printed substrate.

### EXAMPLES

The following illustrates examples of the materials, methods and related aspects described herein. Thus, these examples should not be considered as restricting the present disclosure, but are merely n place to teach how to make examples of the present disclosure. As such, a representative number of compositions and their method of manufacture are disclosed herein.

Materials

Waxes

Efka RM 1920 (available from BASF): hydrogenated castor oil.

Finawax E (available from Petrus): erucamide

Thermoplastic Resins

Nucrel® 699 (available from DuPont): a copolymer of ethylene and methacrylic acid, made with nominally 11 wt. % methacrylic acid.

AC-5120 (available from Honeywell): ethylene-acrylic acid copolymer with an acrylic acid content of 15 wt. % and an acid number of 112-130 KOH/g.

Carrier Liquid

Isopar L (available from EXXON): an isoparaffinic oil.

Charge Adjuvant and Grinding Agent

VCA (available from Sigma-Aldrich): an aluminium stearate.

Charge Director

NCD: a natural charge director having the components (i) natural soya lecithin, (ii) basic barium petronate, and (iii) dodecyl benzene sulfonic acid, amine salt, with the components (i), (ii) and (iii) being present in the weight ratios of 6.6%:9.8:3.6%.

Electrostatic Ink

Cyan ElectroInk 4.5 (available from HP Indigo): a 2 wt. % NVS electrostatic ink composition formed by grinding a 40 wt. % solids paste comprising a 4:1 ratio of Nucrel 699 and AC-5120 resins in Isopar L with cyan pigment (a 92:8 mixture of Helogen Blue 7086 and Helogen Green 8730, both available from BASF (19 wt. % of solids) and VCA (1.2 wt. %). A charge director (NCD, estimated 100 mg per 1 g of ink) was added to the 2 wt. % NVS ink composition before printing.

Electrostatic Overcoat Composition 1

A paste of the second thermoplastic resin was formed by mixing the resins Nucrel 699 and AC-5120 together (ratio of 4:1) at 25 wt. % NVS in the presence of a carrier liquid (Isopar L) in a Ross mixer (Model DOPM-2, obtained from Charles Ross & Son Company—Hauppauge N.Y.) at 120-150° C. and 50 rpm for 90 min, and then the RPM was raised to 70 for 120 min. Subsequently, the temperature was lowered to room temperature and, after 30 min, the RPM was lowered to 50 to obtain a paste of the second thermoplastic resin.

A transparent electrostatic overcoat composition was prepared by combining together Efka RM1920 (a wax; 51.3 g), the paste of the second thermoplastic resin (19.38 g of a 25 wt. % NVS paste of Nucrel 699 and AC5120 (4:1) in Isopar L) and VCA (grinding agent and charge adjuvant; 0.86 g) and adding Isopar L (228.47 g) before grinding (at 245 rpm and 25° C.) for 24 hours. The composition was then diluted with Isopar L to 2 wt. % solids. A charge director (NCD, estimated 100 mg per 1 g of ink) was added to the 2 wt. % NVS ink composition before printing.

Thus, the wax constitutes 90 wt. % of the solids of the electrostatic overcoat composition.

Electrostatic Overcoat Composition 2

A transparent electrostatic overcoat composition was prepared according to the process used for Electrostatic Overcoat Composition 1 except that 14.25 g of Efka RM1920 was used with 167.58 g of the 25 wt. % NVS paste of the second thermoplastic resin and 0.86 g of VCA in the grinding step.

Thus, the wax constitutes 25 wt. % of the solids of the electrostatic overcoat composition.

Electrostatic Overcoat Composition 3

A transparent electrostatic overcoat composition was prepared by combining transparent ElectroInk 4.0 (140 g; available from HP Indigo; a 19 wt. % NVS composition containing a second thermoplastic resin (a 4:1 ratio of Nucrel 699 and AC-5120) resins, VCA and NCD) with a pre-ground 22.8 wt. % NVS mixture of Finawax E (98.5 wt. %) and VCA (1.5 wt. %) in Isopar L (6.14 g). The composition was then diluted with Isopar L to 2 wt. % solids.

Thus, the wax constitutes 5 wt. % of the solids of the electrostatic overcoat composition.

### Examples 1 to 3

A printed substrate was provided by electrostatically printing a cyan ink layer (Cyan ElectroInk 4.5) on a surface of a paper substrate (300 g/m² Condat paper) with an HP Indigo 7000 series LEP printing press. An electrostatic overcoat composition was then electrostatically printed onto the cyan ink layer of the printed substrate with the same HP Indigo 7000 series LEP printing press to form the printed product.

### Reference Example

The reference example was a printed substrate formed as described for Examples 1 to 3, without the application of the electrostatic overcoat composition.

Test 1—Contact Angle

The contact angle of water applied to the printed products was measured by using a Mobile Surface Analyzer (MSA, available from Kruss). The results are shown in Table 1 below.

TABLE 1

| | Contact angle |
|---|---|
| | (H₂O) |
| Example 1 | 106 |
| Example 2 | 105 |
| Example 3 | 116 |
| Reference Example | 94 |

As shown by the results in Table 1, the water contact angle is increased by the use of the electrostatic overcoat composition, resulting in a more hydrophobic printed product.

Test 2—Lamination Bond Strength

The lamination bond strength (LBS) was determined by using a peeling test. A strip of adhesive tape (Scotch tape 810, available from 3M) was applied to the printed product. The lamination bond strength between the tape and the overcoat layer was determined by using an LS Series Universal Test Machine (available from Lloyd Instruments) to peel the tape from the printed product, giving the lamination bond strength. Thus, a lower LBS indicates a reduction in adhesion of the tape to the printed product. The results are shown in Table 2 below.

TABLE 2

| | LBS |
|---|---|
| | [N/inch] |
| Example 1 | 0.35 |
| Example 2 | 0.28 |
| Example 3 | 0.3 |
| Reference Example | 1.1 |

For Examples 1 to 3, the adhesive tape, after removal from the printed product, had no electrostatic ink or electrostatic overcoat composition adhered to the tape. Thus, both the ink layer and the overcoat composition remained on the printed substrate after the removal of the tape from the printed product. In contrast, the cyan ink was at least partially removed from the Reference Example printed product.

1. A process for preparing a printed product comprising:
providing a printed substrate comprising an electrostatic ink layer on a surface of a substrate, the electrostatic ink layer comprising a first thermoplastic resin and a pigment; and
electrostatically printing an electrostatic overcoat composition onto the printed substrate, the electrostatic overcoat composition comprising a second thermoplastic resin and a wax.

2. The process for preparing a printed product according to claim 1, wherein the wax constitutes at least 5 wt. % of the solids of the electrostatic overcoat composition.

3. The process for preparing a printed product according to claim 1, wherein the wax constitutes 90 wt. % or less of the solids of the electrostatic overcoat composition.

4. The process for preparing a printed product according to claim 1, wherein the wax is selected from vegetable wax, mineral wax, petroleum wax, paraffin wax, microcrystalline wax, synthetic Fischer-Tropsch waxes, and amide-modified wax.

5. The process for preparing a printed product according to claim 1, wherein the wax is selected from fatty acid esters, fatty acid amides and hydrocarbons, wherein the hydrocarbons comprise at least 25 carbon atoms.

6. The process for preparing a printed product according to claim 1, wherein the wax is selected from fatty acid esters and fatty acid amides.

7. The process for preparing a printed product according to claim 6, wherein the fatty acid ester or fatty acid amide comprises or is derived from a saturated fatty acid or an unsaturated fatty acid, a straight-chain fatty acid, a branched chain fatty acid, a cyclic fatty acid or a mixture thereof.

8. The process for preparing a printed product according to claim 6, wherein the fatty acid amide is producible by amidation of at least one fatty acid with an amino alkane or wherein the fatty acid amide is producible by amidation of a plurality of fatty acids with a polyamino alkane.

9. The process for preparing a printed product according to claim 6, wherein the fatty acid ester is producible by esterification of at least one fatty acid with an alcohol or wherein the fatty acid ester is producible by esterification of a plurality of fatty acids with a polyol.

10. The process for preparing a printed product according to claim 6, wherein the fatty acid ester is a mono-, di- or triglyceride.

11. The process for preparing a printed product according to claim 1, wherein the second thermoplastic resin comprises a polymer having acidic side groups.

12. The process for preparing a printed product according to claim 1, wherein the second thermoplastic resin comprises a copolymer of an alkylene monomer and a monomer selected from acrylic acid or methacrylic acid.

13. A printed product comprising:
a substrate;
an electrostatic ink layer disposed on the substrate, wherein the electrostatic ink layer comprises a first thermoplastic resin and a pigment; and
an overcoat layer disposed on the electrostatic ink layer, the overcoat layer comprising an electrostatic overcoat composition comprising a second thermoplastic resin and a wax.

14. An ink set comprising:
an electrostatic ink composition comprising a first thermoplastic resin and a pigment; and
an electrostatic overcoat composition comprising a second thermoplastic resin and a wax, wherein the wax constitutes at least 5 wt. % of the solids of the electrostatic overcoat composition.

15. The ink set according to claim 14, wherein the wax is selected from fatty acid esters and fatty acid amides.

16. The ink set according to claim 14, wherein the wax constitutes at least 30 wt. % of the solids of the electrostatic overcoat composition.

17. An electrostatic overcoat composition comprising
a thermoplastic resin; and
a wax;
wherein the wax is selected from fatty acid esters and fatty acid amides; and
wherein the wax constitutes at least 5 wt. % of the solids of the electrostatic overcoat composition.

18. The electrostatic overcoat composition according to claim 17, wherein the wax constitutes at least 30 wt. % of the solids of the electrostatic overcoat composition.

19. The electrostatic overcoat composition according to claim 17, wherein the wax is a fatty acid ester and constitutes at least 30 wt. % of the solids of the electrostatic overcoat composition.

20. The electrostatic overcoat composition according to claim 17, wherein the wax is a fatty acid amide and constitutes at least 5 wt. % of the solids of the electrostatic overcoat composition.
